(19) United States
(12) Patent Application Publication
(10) Pub. No.: US 2013/0199979 A1
(43) Pub. Date: Aug. 8, 2013

(54) FLUID FILTER

(71) Applicants: Stefan Jauss, Donzdorf (DE); Stefan Seidel, Stuttgart (DE)

(72) Inventors: Stefan Jauss, Donzdorf (DE); Stefan Seidel, Stuttgart (DE)

(73) Assignee: MAHLE INTERNATIONAL GMBH, STUTTGART (DE)

(21) Appl. No.: 13/814,452

(22) PCT Filed: Jul. 25, 2011
(86) PCT No.: PCT/EP11/62709

§ 371 Date: Apr. 22, 2013

(30) Foreign Application Priority Data
Aug. 6, 2010 (DE) 10 2010 033 682.3

(51) Int. Cl. B01D 35/00

(52) U.S. Cl. CPC B01D 35/005
USPC 210/181

(57) ABSTRACT

A fluid filter may include a filter housing including a pot and a lid. A ring filter element may be arranged within the filter housing, through which flow may pass radially and which separates an untreated space from a clean space. The ring filter element may have an upper and a lower end disc. A heating device may be configured to allow heating of the fluid to be filtered. The filter housing may define a port into which the heating device is inserted and the port may separate the heating device from the fluid to be heated.

### CROSS-REFERENCE TO RELATED APPLICATIONS

This application claims priority to German Patent Application 10 2010 033 682.3 filed on Aug. 6, 2010, and International Patent Application PCT/EP2011/062709 filed on Jul. 25, 2011, both of which are hereby incorporated by reference in their entirety.

### TECHNICAL FIELD

The present invention relates to a fluid filter having a filter housing formed by a pot and a lid, in which a ring filter element through which flow passes radially is arranged, according to the preamble of claim 1.

### BACKGROUND

Generic fluid filters which are formed for example as fuel filters or urea solution filters are known from the prior art. In particular if diesel fuel or urea solution are used as the fluid, such filters usually also have a heating device in order to prevent thickening of the fuel in the case of diesel or freezing in the case of urea solution at cold outside temperatures and thereby to be able to maintain the filtering function of the fluid filter over a wide temperature range. Although, heating of the fluid to be filtered is unavoidable for maintaining filter functioning, it entails difficulties such as interactive processes between the heating device and the fluid to be filtered, which can only be controlled with difficulty, for example deposition processes or corrosion processes on the heating device.

### SUMMARY

The present invention is concerned with the problem of specifying an improved or at least an alternative embodiment for a fluid filter of the generic type, which is characterised in particular by a high functional reliability.

This problem is solved according to the invention by the subject matter of the independent claim 1. Advantageous embodiments form the subject matter of the dependent claims.

The present invention is based on the general concept, in a fluid filter having a heating device for heating the fluid to be filtered, of arranging the latter in a heat-transmitting port so that it does not come into direct contact with the fluid to be heated and therefore no interactive processes between the heating device and the fluid to be filtered are likely. Such interactive processes play an important role in particular in a configuration of the fluid filter as a urea solution filter, as the urea solution usually promotes corrosion processes on the heating device, which have an adverse effect on the service life of the heating device and therefore also of the fluid filter. The fluid filter according to the invention, which can for example be configured as a urea solution filter, has a pot and a lid, which together form a filter housing in which a ring filter element is arranged, through which flow passes radially. The latter separates an untreated space from a clean space in the usual manner and has both an upper and a lower end disc. According to the invention, a heat-transmitting port in the form of a pocket, into which the heating device can be inserted, is provided on the pot of the filter housing. The pot of the filter housing is mounted fixedly to the vehicle. This port forms a fluid partition between the heating device and the fluid to be heated, so that they do not come into direct contact with each other at any time. In particular if the fluid filter is configured as a urea solution filter, it provides the great advantage that damage to the individual parts of the heating system owing to the aggressive medium is prevented.

In an advantageous development of the solution according to the invention, the filter housing is formed from plastic or stainless steel or another urea-solution-resistant material, and the port is formed on the filter housing, in particular on the pot of the same. The pot of the filter housing is preferably formed in one piece, but the port can also be attached in a fluid-tight manner to the bottom or to the side walls of the pot of the filter housing. Such a port in the form of a pocket can thus be produced in a manner which is cost-effective and simple in manufacturing terms in a single injection-moulding process together with the filter housing or together with the pot of the filter housing. The port can be open to the outside so that the heating device can generally be inserted into the port from the outside or pulled out of the same without the filter housing per se having to be opened. Of course, the plastic selected for the port is temperature-resistant to such an extent that it can absorb the temperatures generated by the heating device without damage even in the long term.

In an advantageous development of the solution according to the invention, the port extends into an interior of the ring filter element. In this case, the untreated space of the fluid filter lies in the interior of the ring filter element, the heating device consequently being arranged on the untreated side of the ring filter element and heating the fluid which is still to be filtered there. The arrangement of the port in the interior of the ring filter element allows a solution with particularly optimised installation space, which does not require any additional installation space. The available filter surface area is also optimally utilised thereby. Alternatively, the heating device can also be provided only in the inflow region of the untreated side.

In an advantageous development of the solution according to the invention, the heating device introduced into the port can have feed line and discharge line connecting pieces for coolant coming from the engine and a flow guide which ensures that the heating fluid flows optimally through the port. The shape of the flow guide is selected such that the heating fluid has the best possible thermal contact with the walls of the port.

In an advantageous development of the solution according to the invention, the heating device introduced into the port can have an electrical heating device, it being necessary for the heating elements to have the best possible thermal contact with the walls of the port. Self-regulating PTC heating elements or resistance heating systems are preferably used. The heating elements can be integrated in the walls of the port or have thermally conductive contact with the walls of the port.

In principle, a different arrangement of the inlet and outlet connecting pieces is also possible. There may be the condition that the port, the heating device and the inlet connecting piece are integrated in the lid. The ring filter element may then have to be adapted and flow pass through it from the outside to the inside depending on the structure.

Further important features and advantages of the invention can be found in the subclaims, the drawings and the associated description of the figures using the drawings.

It is self-evident that the features which are mentioned above and those which are still to be explained below can be used not only in the combination specified in each case, but also in other combinations or alone without departing from the scope of the present invention.

Preferred exemplary embodiments of the invention are shown in the drawings and are explained in more detail in the following description, with the same reference symbols referring to the same or similar or functionally identical components.

### BRIEF DESCRIPTION OF THE DRAWINGS

In the figures,

FIG. 1 schematically shows a sectional diagram through a fluid filter according to the invention,

FIG. 2 schematically shows an exploded diagram of the fluid filter according to the invention.

### DETAILED DESCRIPTION

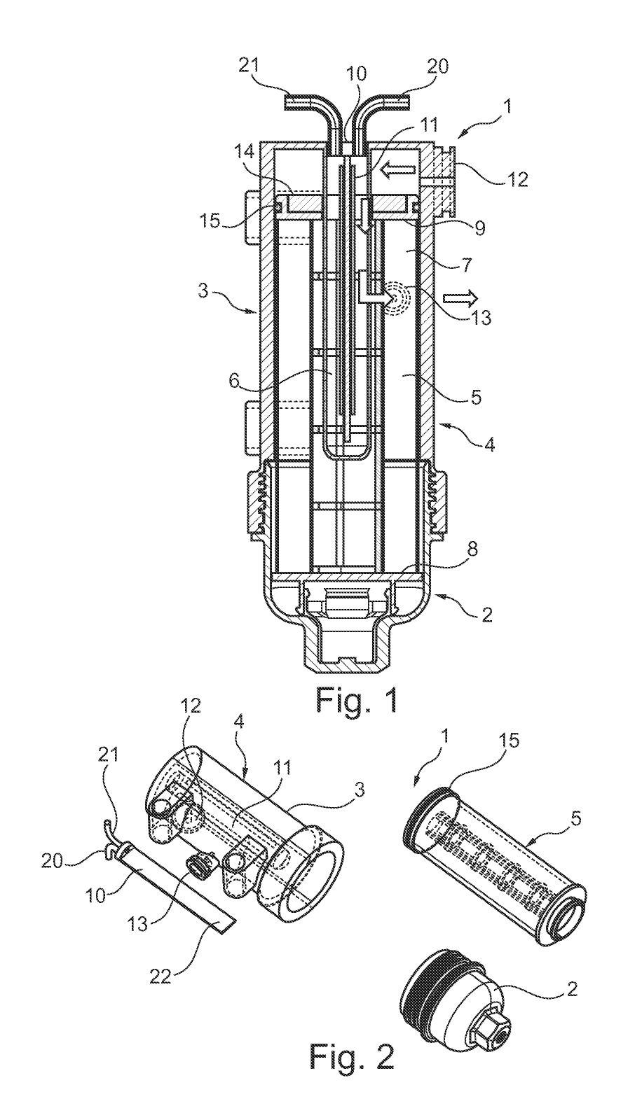

According to FIGS. 1 and 2, a fluid filter 1 according to the invention, which can for example be configured as a urea solution filter, has a filter housing 4 which is formed by a pot 3 and a lid 2 and in which a ring filter element 5 is arranged, through which flow passes radially from the inside to the outside. The ring filter element 5 separates an internal untreated space 6 from an external clean space 7, the ring filter element 5 also having a lower end disc 8 and an upper end disc 9. A heating device 10 is provided, which makes it possible to heat the fluid to be filtered, in particular the urea solution to be heated. According to the invention, a port 11 is provided on the filter housing 4, in particular on the pot 3 of the same, into which port the heating device 10 can be inserted, the said port 11 fluidically separating the heating device 10 from the fluid to be heated, that is, the urea solution to be heated, so that the heating device 10 does not come into direct contact with the fluid. As the urea solution has a highly corrosive action, in particular when heated, the port 11 provided according to the invention can reliably prevent a corrosion process on the heating device 10, as the heating device 10 does not come into direct contact with the urea solution at any time. Urea solution means an approximately 32.5% aqueous solution of urea (H₄N₂O).

The filter housing 4 and in particular the lid 2 and the pot 3 can be formed from plastic, it being possible to form the port 11 on the filter housing 4, that is, in particular on the pot 3 of the same. The pot 3 of the filter housing 4 is preferably mounted fixedly in the vehicle. Both an inlet duct 12 and an outlet duct 13 are arranged on the pot 3, the outlet duct 13 being arranged on a lateral surface of the pot 3 or alternatively on the lid 2. A depth stop 14 extending in the circumferential direction and pointing radially inwards can generally be formed on the filter housing 4, against which depth the ring filter element 5 bears in a leakproof manner with its end disc 9 and thereby separates the untreated space 6 from the clean space 7 and excessively deep insertion of the ring filter element 5 into the filter housing 4 is reliably prevented. The ring filter element 5 bears with its end face of its upper end disc 9 against the depth stop 14.

Furthermore, e.g. an O-ring seal 15 can be provided on the upper end disc 9 of the ring filter element 5, which seal seals off the end disc 9 from a lateral surface of the pot 3 and thereby likewise ensuring reliable separation of the untreated space 6 from the clean space 7. The O-ring seal 15 is preferably accommodated in a groove in the upper end disc 9. Alternatively, other shapes of the seal between the ring filter element 5 and the pot 3 of the filter housing 4 can also be provided, such as a sealing lip running around the outside of the upper end disc 9, or a moulded seal injection-moulded onto the upper end disc 9.

In FIG. 1, the arrows indicate the path of the urea solution through the filter device 1. The urea solution pumped out of the urea solution tank passes through the inlet connecting piece 12 into the filter device 1. The urea solution then flows around the port 11, which is situated inside the ring filter element 5. The urea solution then passes through the filter medium and leaves the filter device 1 via the outlet connecting piece 13.

The pocket-like port 11 can generally be configured in such a manner that it is open to the outside, so that the heating device 10 can be inserted into the port 11 from outside the filter housing 4. As can be seen in particular in FIG. 1, the port 11 extends into an interior of the ring filter element 5 and is arranged in a space-saving manner. The heating device 10 can generally be connected to the port 11 or to the pot 3 of the filter housing 4 of the fluid filter 1 by means of a latching connection, a clamping connection, a screw connection, a welded connection, a bayonet connection or a clip connection.

The heating device 10 is preferably welded in a leakproof manner to the filter housing 4. However, if the option of replacing the heating device 10 is desired, a detachable connection of the heating device 10 to the filter housing is necessary. The heating device 10 is functionally composed of the port 11 into which the respectively selected configuration is inserted and the inserted configuration, i.e. the port 11 can be removed from the filter housing 4 together with the heating device 10 or by itself

A heating fluid can flow through the heating device 10 itself depending on requirements, as shown in FIGS. 1 and 2, or alternatively the heating device can have electrical heating elements (not shown). For through-flow with a heating fluid, for example warm coolant coming from the engine, the heating device 10 has an inlet connecting piece 20 and an outlet connecting piece 21. To optimise flow through the port 11, the heating device 10 also has means 22 for deflecting the flow. This flow deflection means 22 can be sword-shaped, as shown in FIG. 2, but can also have any other shape. In the example shown, guides are also provided on the outer wall of the port 11 for inserting the flow deflection means 22.

Alternatively, electrical heating elements can also be provided in the heating device 10. In this case it should be ensured that the heating elements lie closely against the walls of the port 11 in order to achieve the best possible heat transfer through the wall to the urea solution in the filter housing 4. The heating elements and their electrical feed lines can be integrated in the walls of the port 11. Small means for fastening can also be attached to the side of the wall which faces away from the fluid, into which means the heating elements can be inserted.

The port 11 can also be formed separately from the filter housing 4 and then connected in a fluid-tight manner to the filter housing 4. It forms a type of leakproof immersible pipe, which would be open to the outside if it were not closed by the respective configuration.

The port 11 can penetrate approx. two thirds of the ring filter element 5, as shown in FIG. 1, or more or less depending on the requirements of the filter device 1. The lid 2 of the filter housing 4 can have a drainage screw for draining the fluid situated in the filter housing 4, e.g. the urea solution, for maintenance purposes. During maintenance, the fluid is then drained using the drainage screw and then the filter element 5 is removed with the lid 2 of the filter housing. To this end, the lower, closed end disc 8 has latching means which interact with counter latching means in the lid 2.

The fluid situated in the filter housing 4 can be heated particularly effectively and quickly by the heating device 10 provided according to the invention on the filter housing 4, as only small liquid spaces are present in which the fluid can freeze.

With the fluid filter 1 according to the invention, the service life thereof can be clearly lengthened and thus the functional reliability can be improved in particular, as direct contact between the heating device 10 and the fluid to be filtered, that is, the urea solution to be filtered, can be reliably excluded by the port 11 provided according to the invention. Corrosion processes on the heating device 10 which shorten service life can in particular be avoided thereby.

1. A fluid filter, comprising:
a filter housing including a pot and a lid, a ring filter element arranged within the filter housing through which flow passes radially and which separates an untreated space from a clean space, wherein the ring filter element has an upper and a lower end disc,
a heating device configured to allow heating of the fluid to be filtered,
the filter housing defining a port into which the heating device is inserted, wherein the port separates the heating device from the fluid to be heated.

2. The fluid filter according to claim 1, wherein the filter housing is formed from at least one of plastic, stainless steel, and another urea-solution-resistant material.

3. The fluid filter according to claim 1, wherein the port is thermally conductive.

4. The fluid filter according to claim 1, further comprising a depth stop formed on the filter housing and extending in the circumferential direction and pointing radially inwardly and against the ring filter element in a leakproof manner with an end disc and thereby separating the untreated space from the clean space.

5. The fluid filter according to claim 1, wherein the heating device is inserted into the port from outside the filter housing.

6. The fluid filter according to claim 1, wherein the port extends into an interior of the ring filter element.

7. The fluid filter according to claim 1, further comprising an inlet duct arranged in the pot and an outlet duct arranged at least one of on a lateral surface of the pot and in the lid.

8. The fluid filter according to claim 1, wherein an inlet duct is arranged in the lid and an outlet duct is arranged at least one of on a lateral surface of the pot and on the pot.

9. The fluid filter according to claim 1, wherein the heating device is connected in a leakproof manner to at least one of the port and the filter housing by one of a welded connection, a latching connection, a clamping connection, a screw connection and a clip connection.

10. The fluid filter according to claim 1, wherein the heating device has a flow deflection mechanism and an inlet connecting piece and an outlet connecting piece for heating fluid, of an internal combustion engine.

11. The fluid filter according to claim 1, wherein the heating device has electrical heating elements having thermally conductive contact with walls of the port.

12. The fluid filter according to claim 2, wherein the port is thermally conductive.

13. The fluid filter according to claim 12, further comprising a depth stop formed on the filter housing-and extending in the circumferential direction and pointing radially inwardly and against the ring filter element in a leakproof manner with an end disc and thereby separating the untreated space from the clean space.

14. The fluid filter according to claim 13, wherein the heating device is inserted into the port from outside the filter housing.

15. The fluid filter according to claim 14, wherein the port extends into an interior of the ring filter element.

16. The fluid filter according to claim 15, further comprising an inlet duct arranged in the pot and an outlet duct arranged at least one of on a lateral surface of the pot and in the lid.

17. The fluid filter according to claim 16, wherein an inlet duct is arranged in the lid and an outlet duct is arranged at least one of on a lateral surface of the pot and on the pot.

18. The fluid filter according to claim 17, wherein the heating device is connected in a leakproof manner to at least one of the port and the filter housing by one of a welded connection, a latching connection, a clamping connection, a screw connection and a clip connection.

19. The fluid filter according to claim 18, wherein the heating device has a flow deflection mechanism and an inlet connecting piece and an outlet connecting piece for heating fluid of an internal combustion engine.

20. The fluid filter according to claim 19, wherein the heating device has electrical heating elements having thermally conductive contact with walls of the port.
